(19) United States
(12) Patent Application Publication
(10) Pub. No.: US 2022/0027859 A1
(43) Pub. Date: Jan. 27, 2022

(54) SMART USER INTERFACE FOR CALENDAR ORGANIZATION TO TRACK MEETINGS AND ACCESS CONSOLIDATED DATA

(71) Applicant: Avaya Management L.P., Santa Clara, CA (US)

(72) Inventors: Navin Daga, Silapathar (IN); Sandesh Chopdekar, Pune (IN); Pushkar Yashavant Deole, Pune (IN)

(21) Appl. No.: 16/936,943

(22) Filed: Jul. 23, 2020

(51) Int. Cl. G06Q 10/10; G06N 20/00; G10L 15/26

(52) U.S. Cl. CPC G06Q 10/1095; G06Q 10/107; G10L 15/26; G06N 20/00

(57) ABSTRACT

The present disclosure provides, among other things, methods and systems of managing communications, the methods and systems including: receiving a first meeting communication; receiving a second meeting communication; determining at least one matching variable in common between the first meeting communication and the second meeting communication; comparing a property of the at least one matching variable to a first threshold to determine a configuration of an organizational action; and based on the comparison of the property, performing the organizational action

### FIELD

Embodiments of the present disclosure relate generally to communication methods and specifically to organizing and accessing electronic data.

### BACKGROUND

Current users of various communication modalities have a lot of data to track, view, and organize, and the data is often spread across various channels. Further, the data may be stored in multiple locations (e.g., in different storage areas or mediums), which compounds the problems with needing to track, view, and organize the data.

### BRIEF SUMMARY

Thus, there is a need for a user interface that enables fast and easy organization and also provides a unified and consolidated view of data that is spread across a number of locations and/or channels. When a user has to access data from different locations and/or channels, it can be time consuming to access each location/channel and view or collect all the data of interest because, for example, the user must navigate to multiple different locations. In addition, if the user has trouble remembering a location and/or channel of a particular item, or if the user is unsure of what data is related to an item of interest, this can be additionally time consuming, frustrating, and result in other problems such as the inefficient collection of data.

Other circumstances can also contribute to the issues. If the user has a limited screen area through which to navigate, then the user can find it challenging to perform multiple navigation tasks to look for or to collect data. Also, different types of devices have different capabilities (e.g., mobile devices may not have a same calendar application as a user's other computing devices) and certain functionality may be constrained due to the differences in capabilities. For example, a user's mobile device may have a version of a calendar application that has limited ability to attach documents related to a meeting. Or the user may not be able to create a folder containing all relevant data due to a device's limited memory. Also, if a screen size is small, the user may find it difficult to view multiple pieces of information, especially if the user is trying to view multiple pieces of information at a same time. For these reasons and others, the user also may not be able to view, collect, and/or organize all of the data of interest, resulting in various problems such as added costs from wasted time, errors, repeated work, incomplete information, etc.

The information needing to be organized can include information related to meetings and meeting outcomes. For example, a meeting may be a recurring meeting on a topic; however, the meeting may not be set up as a recurring meeting. Thus, attendees of the meeting, or other users associated with the meeting, may need to look up each meeting individually to find any related information. Also, the attendees and users may need to track and view additional information related to each meeting (e.g., meeting minutes and messages exchanged regarding the meetings or topics of the meetings). These problems result in a loss of productivity and added costs.

Embodiments of the present disclosure aim to improve data organization and a user's ability to access such data, including calendar data. Some embodiments of the present disclosure are, therefore, directed towards multiple communications that may be accessed or received by a user, where at least one matching variable may be determined to be in common between the multiple communications. A property of the at least one matching variable may be compared to a threshold to determine a configuration of an organizational action (also referred to herein as an action), such as configuring a user interface to show a consolidated view of information that may include the multiple communications and additional information related to the multiple communications. Then, the user interface may be displayed to at least one user to advantageously display a consolidated and summarized view of the information. In various embodiments, the consolidated view may show recurring meetings having a same or similar topic in a separate tab under one topic with details of each meeting held on the topic. Any follow up meetings or information may be identified and included in the consolidated view and clubbed with the existing topic. Meeting minutes, message exchanges, audio or audio-video recordings, and follow ups of each meeting may be consolidated and also shown under the topic.

In certain embodiments, data mining and machine learning tools and techniques will discover one or more of at least one matching variable, one or more properties of the at least one matching variable, comparison(s) to threshold(s), organizational action(s), additional information, and configuration(s) of a user interface, among other embodiments, to inform an improved organization and accessing of data for a user.

Machine learning may be used in the methods and systems disclosed herein. For example, machine learning may determine outcomes of meetings and summarize outcomes. Machine learning may also analyze and summarize other information, such as recordings. Actions and follow up information may be determined by the machine learning, as well as additional information to include in the consolidated view. The machine learning may determine and set various properties and configurations of the consolidated view and updates to the consolidated view. Any of the information and/or summarized information may be modified and act as feedback to the system.

The consolidated view may include one or more timelines. The timelines may display, or otherwise show or link to (e.g., via a hyperlink or a Universal Resource Locator (URL)), information within one or more of the consolidated views. Timelines may be set or configured by a user or by automatic processing. The machine learning may automatically create, update, or configure the timelines and the information associated with the timelines; for example, tracking progress and deadlines or results associated with the timelines and showing future events or proposed future events. In some embodiments, tabs, sub-tabs, menus, sub-menus, lists of information, sub-lists of information, topics, and sub-topics may be determined and incorporated into the timelines by a user, by automatic processes, and/or by machine learning.

In some aspects of the consolidated view, mail exchanges may be shown in a consolidated graphical user interface element, e.g., under a same tab or list. Similarly, recordings (including audio and audio-visual) may be shown as one, e.g., under a same tab or list in the consolidated view. Multiple tabs and/or lists may be shown. A user may configure the consolidated view to personalize how the information is displayed, or the display itself

Thus, the systems and methods disclosed herein include embodiments where information may be determined, created, provided, configured, edited, updated and deleted by user(s) and/or the system itself (e.g., automatically or by machine learning). The system may suggest information and/or organizational actions (or updates to information and/or organizational actions) to user(s), or may automatically perform updates without user input. In various aspects, a learning engine may be used that is capable of learning what has been done on information by users and does the same thing (e.g., finds similar content, topics, related information, configurations of displays, etc.) and/or adjusts organizational actions (including consolidated views) based on the learning.

These and other needs are addressed by the various embodiments and configurations of the present disclosure. The present disclosure can provide a number of advantages depending on the particular configuration. These and other advantages will be apparent from the disclosure contained herein.

According to some aspects of the present disclosure, methods of managing communications include: receiving a first meeting communication; receiving a second meeting communication; determining at least one matching variable in common between the first meeting communication and the second meeting communication; comparing a property of the at least one matching variable to a first threshold to determine a configuration of an organizational action; and based on the comparison of the property, performing the organizational action.

In some embodiments, the performing the organizational action includes at least one of: displaying a related items user interface, displaying a follow up user interface, and displaying a meeting summary based on a content of a first meeting.

In some embodiments, the performing the organizational action includes displaying a related items user interface, where the related items user interface includes a display of the first meeting communication and a display of the second meeting communication.

Another aspect of the disclosure is that the methods further include: after the comparing the property to the first threshold and before the performing the organizational action, searching at least one of a calendar and an email history to find an additional communication related to the at least one matching variable; and requesting a user input to configure a consolidated view of the first meeting communication, the second meeting communication, and the additional communication.

In some embodiments, the performing the organizational action is configuring first information about the first meeting communication and second information about the second meeting communication into a consolidated view, and the methods further including displaying the consolidated view on a display device.

Another aspect of the disclosure is that the methods further include: after the comparing the property to the first threshold and before the performing the organizational action, searching at least one of a calendar and an email history to find an additional communication related to the at least one matching variable, where the performing the organizational action further includes configuring additional information about the additional communication into the consolidated view to create an updated consolidated view, and where the displaying the consolidated view includes displaying the updated consolidated view.

Another aspect of the disclosure is that the methods further include: after the comparing of the property to the first threshold, monitoring for the at least one matching variable, where at least one of the first meeting communication and the second meeting communication are related to a first user, and where the monitoring is of an activity of the first user.

In some embodiments, the monitoring detects an event containing the at least one matching variable, where the performing the organizational action is configuring first information about the first meeting communication and second information about the second meeting communication into a first consolidated view, and the methods further include: displaying the first consolidated view on a display device; and displaying a second consolidated view on the display device, where the second consolidated view comprises third information about the event.

Another aspect of the disclosure is that the methods further include: storing the at least one matching variable in a database of communication decisions; enabling a machine learning process to analyze the database of communication decisions; and updating a data model used to automatically perform, based on the analysis performed by the machine learning process, analyses of matching variables including the analysis of the at least one matching variable.

In some embodiments, the first meeting communication is a first calendar event having a first voice-to-text transcript, where the second meeting communication is a second calendar event having a second voice-to-text transcript, and where the at least one matching variable is a shared meeting topic obtained by the machine learning process from the first voice-to-text transcript and the second voice-to-text transcript.

Another aspect of the disclosure is that the methods further include: updating the database of communication decisions to store the shared meeting topic.

In some embodiments, the first threshold is set by the machine learning process and the first threshold is stored in the database of communication decisions.

In some embodiments, the machine learning process performs a semantic and/or syntactic analysis of text contained in the first meeting communication and the second meeting communication.

In some embodiments, the machine learning process performs a semantic and/or syntactic analysis of text contained in the first meeting communication and the second meeting communication to obtain the first voice-to-text transcript and the second voice-to-text transcript.

In some embodiments, the first threshold is determined by the machine learning process after the receiving the first meeting communication and after the receiving the second meeting communication, and the first threshold is stored in the database of communication decisions.

According to some aspects of the present disclosure, communication systems include: a processor; and computer memory storing data thereon that enables the processor to: receive a first meeting communication; receive a second meeting communication; determine at least one matching variable in common between the first meeting communication and the second meeting communication; compare a property of the at least one matching variable to a first threshold to determine a configuration of an organizational action; and based on the comparison of the property, perform the organizational action.

In some embodiments, the first meeting communication is an email, the second meeting communication is a calendar event, the property is a key word, and the threshold is a number of repetitions of the key word.

In some embodiments, the first meeting communication is an email, the second meeting communication is a calendar event, the property is a key word, and the threshold is a location of the key word in each of the email and the calendar event.

In some embodiments, the performing the organizational action is at least one of creating a new calendar event and creating an action item, wherein the organizational action is based on information from at least one of the first meeting communication and the second meeting communication, and further comprising displaying a confirmation for the organizational action on a display device.

According to some aspects of the present disclosure, contact centers include: a server including a processor and a message routing engine that is executable by the processor and that enables the processor to: receive a first meeting communication; receive a second meeting communication; determine at least one matching variable in common between the first meeting communication and the second meeting communication; compare a property of the at least one matching variable to a first threshold to determine a configuration of an organizational action; and based on the comparison of the property, perform the organizational action.

In some embodiments, the machine learning process performs a semantic and/or syntactic analysis of information. The machine learning process may utilize data models such as Decision Trees, Support Vector Machines (SVMs), Nearest Neighbor, and/or Bayesian classifiers.

Another aspect of the present disclosure is that the method further includes: updating one or more data models used to automatically analyze information other than text-based information based on the analysis performed by the machine learning process.

As used herein, information may include data, including various types of communications and/or messages that are multiple electronic records, text, rich media, or data structures. Communications may be data that is stored on a storage/memory device, and/or transmitted from one communication device to another communication device via a communication network. A message may be transmitted via one or more data packets and the formatting of such data packets may depend upon the messaging protocol used for transmitting the electronic records over the communication network. Information may contain different types of information, which is also referred to as content and data herein.

As used herein, a data model may correspond to a data set that is useable in an artificial neural network and that has been trained by one or more data sets that describe conversations or message exchanges between two or more entities. The data model may be stored as a model data file or any other data structure that is useable within a neural network or an Artificial Intelligence (AI) system.

As used herein, the term organizational action refers to various types of actions, including but not limited to processing information using processing decisions as described herein, configuring/displaying/updating one or more consolidated views (also referred to as a display, related items user interface, and a smart user interface), displaying various types of information, determining additional related information and actions to perform for the additional related information, requesting input, searching history, monitoring for one or more matching variables and/or key words and/or repeated content, monitoring activity of one or more users, determining topics and related information (e.g., sub-topics), interacting with databases, and creating/editing/deleting action items/events/tasks, among others. Organizational actions can be referred to as simply “actions” herein.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “analyze,” “process,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Illustrative hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Methods described or claimed herein can be performed with traditional executable instruction sets that are finite and operate on a fixed set of inputs to provide one or more defined outputs. Alternatively or additionally, methods described or claimed herein can be performed using AI, machine learning, neural networks, or the like. In other words, a system or contact center is contemplated to include finite instruction sets and/or artificial intelligence-based models/neural networks to perform some or all of the steps described herein.

### BRIEF DESCRIPTION OF THE DRAWINGS

FIG. 1 is a block diagram illustrating a first system in accordance with at least some embodiments of the present disclosure;

FIG. 2 is a block diagram illustrating a second system in accordance with at least some embodiments of the present disclosure;

FIG. 3 is a block diagram illustrating a third system in accordance with at least some embodiments of the present disclosure;

FIG. 4 is a block diagram depicting a consolidated view in accordance with at least some embodiments of the present disclosure; and

FIG. 5 is a flow diagram depicting a first communication method in accordance with at least some embodiments of the present disclosure.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides illustrative embodiments only, and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the illustrative embodiments will provide those skilled in the art with an enabling description for implementing an illustrative embodiment. It should however be appreciated that the present disclosure may be practiced in a variety of ways beyond the specific detail set forth herein.

While the illustrative aspects, embodiments, and/or configurations illustrated herein show the various components of the system collocated, certain components of the system can be located remotely, at distant portions of a distributed network, such as a Local Area Network (LAN) and/or the Internet, or within a dedicated system. Thus, it should be appreciated, that the components of the system can be combined in to one or more devices or collocated on a particular node of a distributed network, such as an analog and/or digital telecommunications network, a packet-switched network, or a circuit-switched network. It will be appreciated from the following description, and for reasons of computational efficiency, that the components of the system can be arranged at any location within a distributed network of components without affecting the operation of the system.

Embodiments of the disclosure provide systems and methods for providing a smart user interface to access consolidated data. In some aspects, machine learning tools may support organizing and accessing of data. Embodiments of the present disclosure are also contemplated to automatically organize and present information, as appropriate, based on rules in combination of thresholds and/or an analysis of previous actions.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

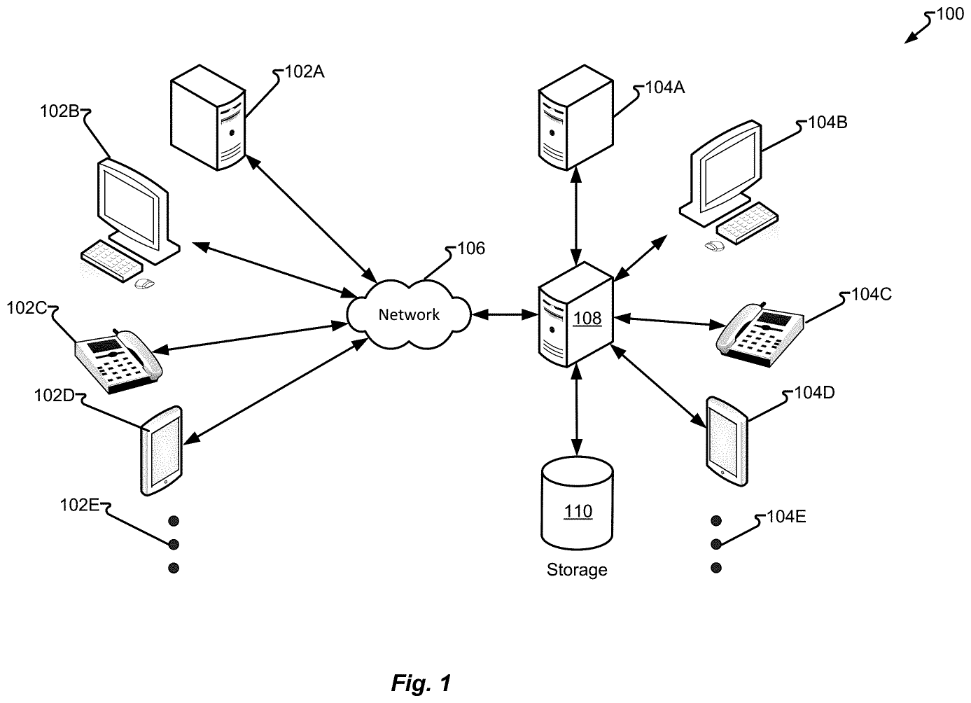

FIG. 1 depicts system 100 in accordance with embodiments of the present disclosure. In one embodiment, first user communication device 102 comprises one or more devices and/or device types, such as first user communication device 102A being a server, computer, or other communication component; first user communication device 102B comprising a computer, laptop, or other application-executing device, such as to execute a softphone, messaging system, video/voice-over-IP, etc. First user communication device 102A and first user communication device 102B may operate independently or cooperatively. First user communication device 102C may be embodied as a telephone (e.g., plain old telephone system (POTS) device, and/or a voice-over-IP (VoIP) device); First user communication device 102D may be a handheld device, such as a personal data assistant, cellular telephone/smart-phone, tablet, etc., which may communicate via cellular communications and/or other wired or wireless networking communications (e.g., WiFi, WiMax, Bluetooth, etc.); and other first user communication device 102E which may comprise other current or future communication devices for use by a user (not shown in FIG. 1) to communicate with one or more second user communication device 104.

In another embodiment, second user communication device 104 comprises one or more devices and/or device types, such as second user communication device 104A which may comprise a server, computer, or other communication component; second user communication device 104B, which may comprise a communication terminal with software and/or communications to other components (e.g., processors, storage/memory devices, etc.); second user communication device 104C which may be embodied a telephone (e.g., POTS, VoIP, etc.); second user communication device 104D may be a handheld device, such as a personal data assistant, cellular telephone/smart-phone, tablet, etc., which may communicate via cellular communications and/or other wired or wireless networking communications (e.g., WiFi, WiMax, Bluetooth, etc.); and other second user communication device 104E which may comprise other current or future communication devices for use by a user (not shown in FIG. 1) to communicate with one or more first user communication device 102.

System 100 omits common components typically utilized to facilitate communication between one or more first user communication device 102 and one or more second user communication device 104. The network 106 can be any type of network familiar to those skilled in the art that can support data communications using any of a variety of commercially-available protocols, including without limitation SIP, TCP/IP, SNA, IPX, AppleTalk, and the like. Merely by way of example, the communication network 104 may correspond to a LAN, such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.9 suite of protocols, the IEEE 802.11 suite of protocols, the Bluetooth® protocol known in the art, and/or any other wireless protocol); and/or any combination of these and/or other networks. Network 106 may be or support communications comprising one or more types (e.g., video, analog voice, digital voice, text, etc.) and/or media (e.g., telephony, Internet, etc.). Network 106 may comprise portions of other networks (e.g., ethernet, WiFi, etc.) and/or virtual networks (e.g., VPN, etc.).

Information related to communications may be referred to herein as communication information or communication data and variations of these terms. Communication information can include any type of data related to communications of a user and/or entity (e.g., information being sent to user(s), received from user(s), created by user(s), accessed by user(s), viewed by user(s), etc.). Communication information can include information associated with the communication as well as information contained within the communication (e.g., content of the communication). Thus, communication information may include information not only that is sent and received, but also other information such as information that a user does not necessarily send or receive. Content of communications may be classified in various ways, such as by a timing of the content, items the content is related to, users the content is related to, key words or other data within fields of the communication (e.g., to field, from field, subject, body, etc.), among other ways of classifying the content. The key words or other content may be analyzed based on various properties, including their location as it relates to the communication (e.g., a field location within the communication).

Communications between ones of first user communication device 102 and ones of second user communication device 104 may be intercepted or monitored by communication server 108 having a microprocessor with a memory integrated therewith or accessible. Communication server 108 monitors the connection data of the communication and, if a criterion or threshold is met, causes at least a portion of the communication to be stored in data storage 110. For example, spoken words, words/characters in a text or email message, properties regarding the communication, etc., may be intercepted, monitored, scanned, searched, and stored. In another embodiment, data storage 110 may maintain an index, pointer, or other indicia to reference to the portion of the communication. The communication server 108 may include, or communicate with, various other servers, memories, modules, and/or engines to implement methods and systems of the present disclosure. The communication server 108 may interact with a set of guidelines (e.g., as a set of static instructions) or by using machine learning. In various embodiments disclosed herein, the communication server 108 may interact with an intelligent organizer server, as described herein.

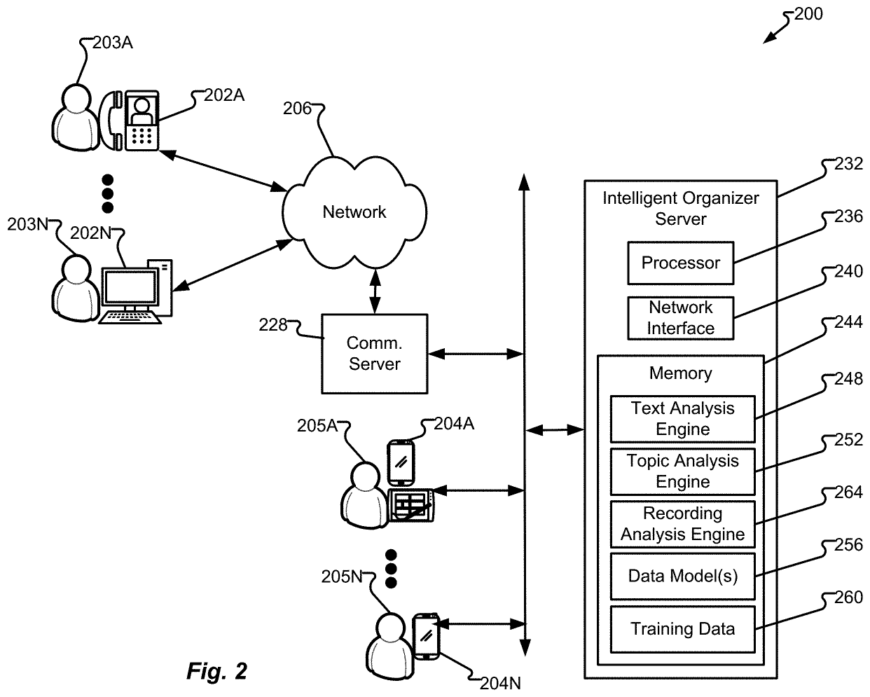

Turning to FIG. 2, a communication system 200 will be described in accordance with at least some embodiments of the present disclosure. In some aspects, the components shown in FIG. 2 may correspond to like components shown in FIG. 1. The communication system 200 is shown to include a communication network 206 that interconnects users 203A-203N via communication devices 202A-202N with users 205A-205N via communication devices 204A-204N. Users may also be referred to herein as humans, human agents, administrators, participants, and attendees. The network 206 may connect to communication devices in any manner, including via communication server 228. Thus, users 205A-205N may communicate with users 203A-203N through their respective devices and communication server 228 in addition to network 206. Communication server 228 may also communicate with intelligent organizer engine 232 via a communication channel.

Communication devices as disclosed herein (e.g., 202A-202N and/or 204A-204N) may correspond to a computing device, a personal communication device, a portable communication device, a laptop, a smartphone, a personal computer, and/or any other device capable of running an operating system, a web browser, or the like. For instance, a communication device may be configured to operate various versions of Microsoft Corp.'s Windows® and/or Apple Corp.'s Macintosh® operating systems, any of a variety of commercially-available UNIX® such as LINUX or other UNIX-like operating systems, iOS, Android®, etc. These communication devices (e.g., 204A-204N and/or 202A-202N) may also have any of a variety of applications, including for example, a database client and/or server applications, web browser applications, chat applications, social media applications, calling applications, etc. A communication device (e.g., 204A-204N and/or 202A-202N) may alternatively or additionally be any other electronic device, such as a thin-client computer, Internet-enabled mobile telephone, and/or personal digital assistant, capable of communicating via communication network 206 and/or displaying and navigating web pages or other types of electronic documents.

In addition, embodiments of the present disclosure contemplate that a user (e.g., 203A-203N and/or 205A-205N) may use multiple different communication devices (e.g., multiple of 202A-202N and/or 204A-204N) to communicate via a single asynchronous communication channel. As a non-limiting example, a user may login to a web-based portal or authenticate themselves with a particular chat channel and then utilize the web-based portal or chat channel to communicate with any one of multiple communication devices (e.g., 204A-204N and/or 202A-202N). Alternatively or additionally, a user may use one of their communication devices (e.g., 204A-204N and/or 202A-202N) to send email messages to another user and use another communication device to send messages of another type (e.g., chat messages or SMS messages) and/or to communicate via a voice channel.

In some embodiments, one or more servers may be configured to perform particular organizational actions or sets of organizational actions specific to supporting functions of the intelligent organizer engine 232. For instance, the communication server 228 may correspond to one or more servers that are configured to receive communications and make routing decisions for the communications, as well as maintain other communication data such as calendar data. The communication server 228 may correspond to a single server or a set of servers that are configured to establish and maintain communication channels between users 203A-203N and 205A-205N and may contain processor(s) and memory to store and manage communications data. In some embodiments, the communication server 228 may work in cooperation with the intelligent organizer engine 232 to manage and process information, as described herein.

In some embodiments, the communication server 228 may be responsible for establishing and maintaining communications including digital text-based communication channels as well as voice channels between users 203A-203N and 205A-205N. The communication server 228 can establish and maintain communication data. As discussed herein, communication data includes and is not limited to any data involving communications of a user and includes calendar and other event information. Thus, as some non-limiting examples, the communication server 228 may be configured to process calendar information and communications received from a user communication device (e.g., 204A-204N and/or 202A-202N) and utilize a calendar protocol and an email messaging protocol. Non-limiting examples of protocols that may be supported by the communication server 228 include Internet Message Access Protocol (IMAP), Post Office Protocol (POP), Simple Mail Transfer Protocol (SMTP), and Exchange. The communication server 228 may alternatively or additionally be configured to support real-time or near-real-time text-based communication protocols, video-based communication protocols, and/or voice-based communication protocols. Various functionality of the communication server 228 may be performed by the intelligent organizer engine 232 and/or other servers and server components such as additional memory and processors (not shown).

It should be appreciated that the communication server 228 may be configured to support any number of communication protocols or applications whether synchronous or asynchronous. Non-limiting examples of communication protocols or applications that may be supported by the communication server 228 include the Session Initiation Protocol (SIP), File Transfer Protocol (FTP), Hypertext Transfer Protocol (HTTP), HTTP secure (HTTPS), Transmission Control Protocol (TCP), Java, Hypertext Markup Language (HTML), Short Message Service (SMS), Internet Relay Chat (IRC), Web Application Messaging (WAMP), SOAP, MIME, Real-Time Messaging Protocol (RTP), Web Real-Time Communications (WebRTC), WebGL, XMPP, Skype protocol, AIM, Microsoft Notification Protocol, email, etc. Again, in addition to supporting text-based communications, the communication server 228 may also be configured to support non-text-based communications such as voice communications, video communications, and the like.

The communication server 228 may also be configured to manage any other type of communication information such as events and action items. The information can be related to entities or users 203A-203N and 205A-205N. For example, the events may be information related to calendar information, meeting information (including meeting topics, dates/times, attendee information, meeting minutes, meeting summaries, voice-to-text transcripts, etc.) and action items. Action items may include activities or tasks to be performed by a user, a group of users, and/or an automated component in connection with a communication and/or an event. Organizational actions include events and action items. The communication server 228 may be configured to maintain state information for one or more users 203A-203N and 205A-205N at any given point in time. The communication server 228 may also be configured to manage and analyze historical information. Historical information may be used as part of training and updating automated engines (e.g., a text analysis engine 248, a topic analysis engine 252, and/or a recording analysis engine 264). In some embodiments, the communication server 228 may further interact with the text analysis engine 248, the topic analysis engine 252, and/or the recording analysis engine 264 to configure the methods and systems disclosed herein. These capabilities of the communication server 228 may be provided by one or more modules stored in memory and executed by one or more processors of the communication server 228.

In addition, the communication server 228 may be responsible for obtaining user 203A-203N and/or 205A-205N information from various sources (e.g., contact information, meeting information, event information, social media, presence statuses, state information, etc.) to support the methods and systems disclosed herein. In some embodiments, the communication server 228 may be configured to maintain a user database that may be internal to, or external from, the communication server 228. The user database (not shown in FIG. 2) may be used to store user information in any number of data formats. The communication server 228 may be configured to obtain and provide relevant user information to any of the text analysis engine 248, the topic analysis engine 252, and/or the recording analysis engine 264, thereby facilitating the intelligent organizer server's 232 ability to implement the methods and systems disclosed herein.

The intelligent organizer engine 232 may be configured to coordinate tasks between the text analysis engine 248, the topic analysis engine 252, and/or the recording analysis engine 264. The intelligent organizer engine 232, the text analysis engine 248, the topic analysis engine 252, and/or the recording analysis engine 264 may have any configuration and may be made up of more or less components than what is shown in FIG. 2. For example, the intelligent organizer engine 232 may perform all of the tasks of the text analysis engine 248, the topic analysis engine 252, and the recording analysis engine 264, as described herein, or each of the text analysis engine 248, the topic analysis engine 252, and/or the recording analysis engine 264 can perform tasks independently, without interacting with the intelligent organizer engine 232. In various embodiments, settings of the intelligent organizer engine 232, or any of its components, may be configured and changed by any users 203A-203N and 205A-205N and/or administrators of the system. Settings can include alerts and thresholds as well as settings related to how information is collected, organized, and displayed. Settings may be configured to be personalized for one or more communication devices (e.g., 204A-204N and/or 202A-202N) and/or users (e.g., 203A-203N and 205A-205N), and may be referred to as profile settings.

The intelligent organizer engine 232 may invoke an organizational action based on thresholds set by automatic processing, by machine learning and/or one or more users 203A-203N and 205A-205N. The thresholds may be set to determine when to perform an organizational action and to determine what organizational actions to perform. For example, if a certain number of meetings are determined to have a shared topic, then the number of these meetings may be compared to a threshold. If the number of meetings meets or exceeds the threshold (e.g., if the threshold is three meetings and the number of the meetings having a shared topic meets or exceeds three meetings), then an organizational action may occur (e.g., configuring and displaying a consolidated view of the meetings and related information). Thresholds may thereby determine various organizational actions, as well as organizational actions that are dependent upon other organizational actions. For example, if a consolidated view regarding meetings having a shared topic is configured and displayed, then the intelligent organizer engine 232 may perform additional organizational actions, such as searching for additional information to include in the consolidated view, updating the consolidated view, and determining action items related to the meetings and/or the topic(s). One or more of these additional actions may occur based on one or more thresholds being met or exceeded. Thus, in some embodiments, the intelligent organizer engine 232 may receive an indication that actions associated with various criteria should be implemented in specified circumstances.

Actions may be associated with any desired information, such as a particular set of key words, one or more topics, etc., and configured with any desired criteria. Actions may be personalized to one or more communication devices (e.g., 204A-204N and/or 202A-202N) and/or users (e.g., 203A-203N and 205A-205N) and may have any properties desired by a user (e.g., a desired run time, preferred programs to use to perform organizational actions, various specified groups of attendees and/or users 203A-203N and 205A-205N, preferred locations, preferred configurations, preferred timings, etc.). Actions can include configuring notification settings (e.g., for a user to be notified of an organizational action or a recommended organizational action) and recording settings (e.g., to record events such as meetings, communications, etc.). The actions can be configured to be implemented automatically (e.g., automatically recording and analyzing meeting discussions).

In some aspects, different thresholds may be used to configure various notifications and/or recordings. For example, the thresholds may correspond to one or more specified sub-topics classified as being within a topic, a detection of a specified number of repetitive words occurring within certain content, locations of key word(s) within information, a detection of a specified number of repetitive words occurring over a specified timeframe, etc. Settings related to actions and thresholds, including data regarding events, notifications, and recordings, may be stored at any location. The settings may be predetermined (e.g., automatically applied by the intelligent organizer engine 232 and/or set or changed based on various criteria). The settings are configurable for any timing or in real-time. For example, monitoring, searching, performing organizational actions, etc., may occur at any timing or continuously in real-time.

Settings related to actions and thresholds can include customized settings for any user, device, or groups of users or devices. For example, users 203A-203N and 205A-205N may each have profile settings that configure one or more of their thresholds, organizational actions, preferred configurations of consolidated views, preferred settings regarding recordings, etc., among other user preferences. Settings chosen by an administrator or a certain user may override other settings that have been set by other users 203A-203N and 205A-205N, or settings that are set by default. Alternatively, settings chosen by a user may be altered or ignored based on any criteria at any point in the process. For example, settings may be created or altered based on a user's association with a position, a membership, or a group, based on a location or time of day, or based on a user's identity or group membership, among others.

Some settings configured by a user can cause an organizational action to occur and notifications to be displayed at one or more communication devices (e.g., 204A-204N and/or 202A-202N) when a threshold is met or exceeded (e.g., to perform an organizational action, such as when a consolidated view is created). Various thresholds may be set for any user (e.g., 203A-203N and 205A-205N) and/or communication device (e.g., 204A-204N and/or 202A-202N) . In addition, intelligent organizer engine 232 may automatically configure one or more thresholds and associated organizational actions. Regardless of how settings were initially configured, thresholds and/or notifications may vary based on a user's preferences (including preferences regarding specific communication devices (e.g., 204A-204N and/or 202A-202N)), properties associated with a user, properties associated with groups of users, and groups that a user is a member of, among others.

Additional capabilities of the intelligent organizer engine 232 will be described in further detail with respect to operation of the text analysis engine 248, the topic analysis engine 252, and the recording analysis engine 264, which are shown to be provided by the intelligent organizer engine 232. While certain components are depicted as being included in the intelligent organizer engine 232, it should be appreciated that such components may be provided in any other server or set of servers. For instance, components of the intelligent organizer engine 232 may be provided in a separate engine (not shown) and/or in the communication server 228, in an engine of the communication server 228, etc., and vice versa. Further still, embodiments of the present disclosure contemplate a single server that is provided with all capabilities of the communication server 228 and the intelligent organizer engine 232.

The memory 244 may include one or multiple computer memory devices. The memory 244 may be configured to store program instructions that are executable by the processor 236 and that ultimately provide functionality of the intelligent organizer engine 232 described herein. The memory 244 may also be configured to store data or information that is useable or capable of being called by the instructions stored in memory 244. One example of data that may be stored in memory 244 for use by components thereof is one or more data model(s) 256 and/or training data 260. The memory 244 may include, for example, Random Access Memory (RAM) devices, Read Only Memory (ROM) devices, flash memory devices, magnetic disk storage media, optical storage media, solid-state storage devices, core memory, buffer memory devices, combinations thereof, and the like. The memory 244, in some embodiments, corresponds to a computer-readable storage media and while the memory 244 is depicted as being internal to the intelligent organizer engine 232, it should be appreciated that the memory 244 may correspond to a memory device, database, or appliance that is external to the intelligent organizer engine 232.

The text analysis engine 248,may be configured to analyze textual information, including voice-to-text information. As described herein, textual information may include and is not limited to calendar information (including scheduling information associated with a particular meeting(s) and/or locations, user calendar and scheduling information, etc.), user preferences, user physical location information, user and/or location contact data, etc.), message information (including textual message information, message responses, message processing history, message key words, message notes, user notes associated with one or more messages, message configurations, message origination(s) and destination(s)), and meeting information (including meeting minutes, meeting notes, to do items, action items, meeting scheduling information, etc.). Voice-to-text information may be any audio information that is converted to text and may include communications with an audio component (e.g., voice calls, voice messages, video calls, meeting recordings, etc.). The textual information may be historical information, or information that is being recorded in real-time. The text analysis engine 248 may provide appropriate signaling to a communication device (e.g., 204A-204N and/or 202A-202N) and/or the communication server 228 that enables the text analysis engine 248 to receive textual information from the communication device(s) and/or the communication server 228.

The topic analysis engine 252 may be configured to analyze topics contained within various types of information, including audio and textual information. The topics may be identified by the topic analysis engine 252 from the information, may be identified within the information itself, and may be identified by external sources, such as from information received from the communication server 228, other information received over the network 206, and/or information received from one or more users 203A-203N and 205A-205N. Topics may be organized and classified in various manners, by relational organization, and including through the use of sub-topics. The organization and classification of topics may be determined by automatic processing, by machine learning and/or one or more users 203A-203N and 205A-205N. The topics may be historical information, or they may be identified by analyzing information in real-time. The topic analysis engine 252 may provide appropriate signaling to a communication device (e.g., 204A-204N and/or 202A-202N) and/or the communication server 228 that enables the topic analysis engine 252 to receive information from the communication device(s) and/or the communication server 228.

The recording analysis engine 264 may be configured to analyze recorded information, including voice-to-text information. The recorded information may be historical information, or information that is being recorded in real-time. As described herein, recorded information may include and is not limited to meeting recordings, voicemail recordings, recordings of a video call, and voice call recordings. The recording analysis engine 264 may provide appropriate signaling to a communication device (e.g., 204A-204N and/or 202A-202N) and/or the communication server 228 that enables the recording analysis engine 264 to receive audio information from the communication device(s) and/or the communication server 228.

The intelligent organizer engine 232 is shown to include a processor 236 and a network interface 240 in addition to memory 244. The processor 236 may correspond to one or many computer processing devices. Non-limiting examples of a processor include a microprocessor, an Integrated Circuit (IC) chip, a General Processing Unit (GPU), a Central Processing Unit (CPU), or the like. Examples of the processor 236 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

The network interface 240 may be configured to enable the intelligent organizer engine 232 to communicate with other machines in the system 200 and/or to communicate with other machines connected with the communication network 206. The network interface 240 may include, without limitation, a modem, a network card (wireless or wired), an infra-red communication device, etc.

Illustratively, the memory 244 is shown to store the text analysis engine 248, the topic analysis engine 252, and/or the recording analysis engine 264 for execution by the processor 236. In some embodiments, each of the text analysis engine 248, the topic analysis engine 252, and/or the recording analysis engine 264 may correspond to a set of processor-executable instructions (e.g., a finite instruction set with defined inputs, variables, and outputs). In some embodiments, the text analysis engine 248, the topic analysis engine 252, and/or the recording analysis engine 264may correspond to an AI component of the intelligent organizer engine 232 that is executed by the processor 236. Each of the text analysis engine 248, the topic analysis engine 252, and/or the recording analysis engine 264, in some embodiments, may utilize one or more data models 256, which may be in the form of an artificial neural network, for recognizing and processing the information obtained from communication devices 202A-202N and/or 204A-204N and/or supported by the communication server 228. In some embodiments, the text analysis engine 248, the topic analysis engine 252, and/or the recording analysis engine 264 may each be trained with training data 260 and may be programmed to learn from additional communication information, including meetings as such meetings are scheduled and/or occur, events as such events are scheduled and/or occur, actions items as such action items are scheduled and/or occur, conversations as such conversations occur, or after any of these items occur. In some embodiments, any one or more of the text analysis engine 248, the topic analysis engine 252, and the recording analysis engine 264 may update one or more of the data models 256 as they learn from ongoing information.

As can be appreciated by one skilled in the art, functions offered by the elements depicted herein may be implemented in one or more network devices (i.e., servers, networked user device, non-networked user device, etc.).

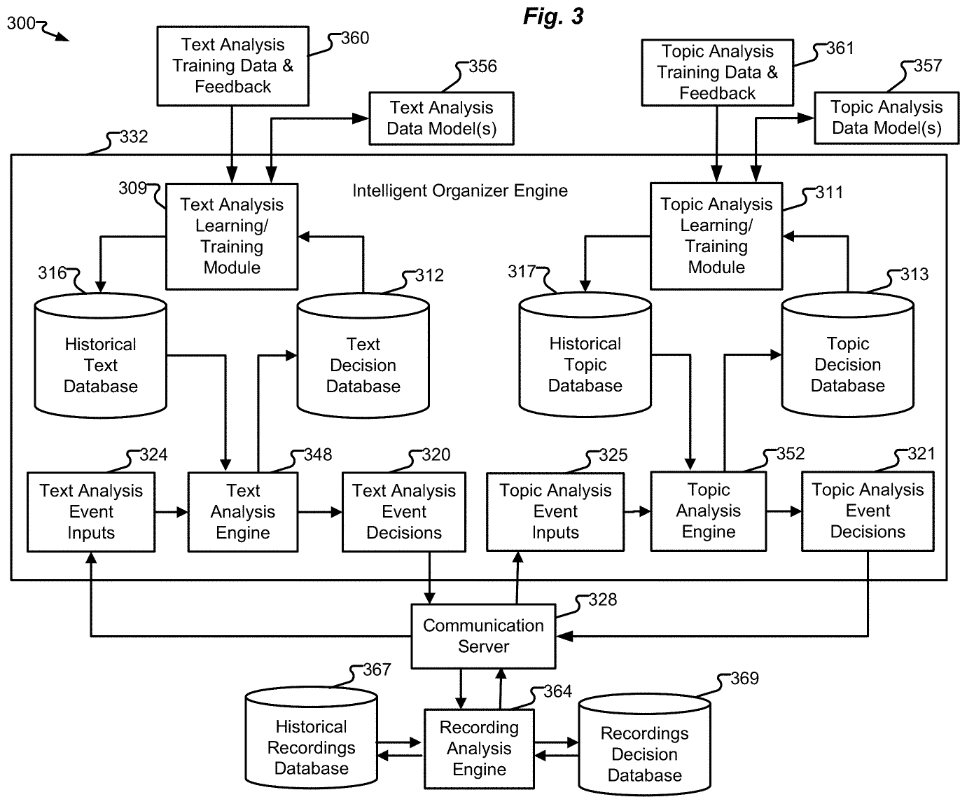

Further details of an intelligent organizer engine 232 utilizing machine learning are described with reference to FIG. 3. In some aspects, the components shown in FIG. 3 may correspond to like components shown in FIGS. 1 and 2. FIG. 3 shows a system 300 including an intelligent organizer engine 332 together with a communication server 328, recording analysis engine 364, and associated components.

In various embodiments, the intelligent organizer engine 332 may correspond to the intelligent organizer engine 232 of FIG. 2. The intelligent organizer engine 332 can create and select appropriate processing decisions. Processing decisions may include one or more of scanning, matching, comparing (e.g., to other communication information or to other set values or variables such as one or more thresholds), displaying, editing, saving, and deleting. Processing data can also include creating, editing, and performing organizational actions. The intelligent organizer engine 332 may manage (e.g., recommend, configure, display, update, revise, edit, delete, and otherwise implement) organizational actions. Processing decisions and organizational actions may be handled automatically by the intelligent organizer engine 332 without human input.

The intelligent organizer engine 332 may manage organizational actions based on input from historical databases (e.g., historical text database 316, historical topic database 317, and/or historical recordings database 367) and based on communication information inputs received from the communication server 328. As explained herein, in some embodiments, various components of system 300 may be combined or not present in system 300; for example, there may be only one training/learning module that operates in combination with a single database containing training data and data models and only one engine that handles all of the components and functionality for text, topics, and recordings.

Components of system 300 may have access to training data 360 and 361. For example, the text analysis training data and feedback 360 may initially train behaviors of the text analysis engine 348 to utilize machine learning, and the topic analysis training data and feedback 361 may initially train behaviors of the topic analysis engine 352 to utilize machine learning. The text analysis engine 348 and the topic analysis engine 352 may each also be configured to learn from further information based on feedback, which may be provided in an automated fashion (e.g., via a recursive learning neural network) and/or a human-provided fashion (e.g., by one or more human users 205A-205N and/or 203A-203N).

The learning/training modules 309 and 311 of the intelligent organizer engine 332 may have access to and use one or more data models 356 and 357. For example, the text analysis data model 356 may be built and updated by the text analysis training/learning module 309 based on the text analysis training data and feedback 360. Similarly, the topic analysis data model 357 may be built and updated by the topic analysis training/learning module 311 based on the topic analysis training data and feedback 361. The data models 356 and 357 may be similar to or different from one another, and may be provided in any number of formats or forms. Non-limiting examples of data models 356 and 357 include Decision Trees, SVMs, Nearest Neighbor, and/or Bayesian classifiers.

The learning/training modules 309 and 311 may also be configured to access information from respective decision databases 312 and 313 for purposes of building each of the respective historical databases 316 and 317, which effectively store historical information. Data within the historical databases 316 and 317 may constantly be updated, revised, edited, or deleted by the respective learning/training modules 309 and 311 as the intelligent organizer engine 332 processes more information received from communication server 328.

Information stored in historical text database 316 may include and is not limited to communication information (including message information that may be textual message information, message responses, message processing history, message key words, message notes, user notes associated with a message, message configurations, and message origination(s) and destination(s)), user preferences regarding textual information, location information (which may be location(s) of text within information, location(s) associated with text, etc.), and meeting information. Meeting information can include meeting minutes, meeting notes, to do items, action items, meeting scheduling information, other calendar information (including scheduling information associated with a particular meeting(s) and/or location(s), user calendar and scheduling information, etc. Textual information obtained by voice-to-text may also be stored in historical text database 316. The textual information may include textual information that was recorded, or was processed by voice-to-text processing, in real-time. Further, information regarding the importance of different text as well as how to determine importance (e.g., location of key words/phrases, repetition of key words/phrases, explicit definitions of importance of text, classifications of text, rankings of text, and user preferences regarding text, etc. may be stored in historical text database 316.

Information stored in historical topic database 317 may include and is not limited to topics related to meetings, events, communications, to do items, and actions items, as well as information related to topics, such as key words, key phrases, information regarding the importance of different types of topics as well as how to determine importance (e.g., location of key words/phrases, repetition of key words/phrases, explicit definitions of topics and importance of topics, classifications of topics, rankings of topics, and user preferences regarding topics, etc.). Topic information obtained by voice-to-text also be stored in historical topic database 317. The topic information may include topic information that was recorded, topic information that was processed (e.g., by voice-to-text processing), in real-time, and proposed topic information.

In some embodiments, the intelligent organizer engine 332 may include multiple engines, such as the text analysis engine 348 and the topic analysis engine 352. In system 300, the text analysis engine 348 has access to the historical text database 316, the text decision database 312, the text analysis event inputs 324, and the text analysis event decisions 320. The topic analysis engine 352 has access to the historical topic database 317, the topic decision database 313, the topic analysis event inputs 325, and the topic analysis event decisions 321.

The text analysis engine 348 may provide appropriate signaling to the communication server 328 that enables the text analysis engine 348 to receive textual information from the communication server 328. Further, if data from the communication devices (e.g., 204A-204N and/or 202A-202N) is not provided via the communication server 328, the text analysis engine 348 may provide appropriate signaling to one or more of the communication devices (e.g., 204A-204N and/or 202A-202N) that enables the text analysis engine 348 to receive textual information from the communication device(s) (e.g., 204A-204N and/or 202A-202N).

The topic analysis engine 352 may provide appropriate signaling to the communication server 328 that enables the topic analysis engine 352 to receive topic information from the communication server 328. Further, if data from the communication devices (e.g., 204A-204N and/or 202A-202N) is not provided via the communication server 328, the topic analysis engine 352 may provide appropriate signaling to one or more of the communication devices (e.g., 204A-204N and/or 202A-202N) that enables the topic analysis engine 352 to receive textual information from the communication device(s) (e.g., 204A-204N and/or 202A-202N).

Each of the text analysis engine 348 and the topic analysis engine 352 can create and select appropriate processing decisions (e.g., recommending, configuring, displaying, updating, revising, editing, deleting, and/or implementing organizational actions) based on input from their respective historical database 316 and 317 and based on communication inputs received from the communication server 328. The communication inputs from the communication server 328 may be provided to the text analysis engine 348 from the text analysis event inputs 324 and may be provided to the topic analysis engine 352 from the topic analysis event inputs 325.

The text analysis event inputs 324 may include information about textual information handled by the communication server 328. For example, the textual information may include text related to entity information, user and non-user information, contact information, events, lists, and action items. The textual information can be related to communications or events, including meeting information. Thus, for example, the communication server 328 may receive information from email and voice-to-text phone calls that includes details regarding a meeting agenda, dates and time of the meeting, and meeting attendee information. The communication server 328 may also receive textual information from the recording analysis engine 364. The communication server 328 may provide all of this textual information to the text analysis event inputs 324. Alternatively, the communication server 328 may provide none or only some of the textual information to the text analysis event inputs 324 based on processing rules. The rules may be established by automatic processing, by machine learning, or they may be defined by a user or entity.

The topic analysis event inputs 325 may include information about topic information handled by the communication server 328. For example, the topic information may include topics related to entity information, user and non-user information, contact information, events, lists, and action items. The topic information can be related to communications or events, including meeting information. Thus, for example, the communication server 328 may receive information from email and voice-to-text meeting minutes that includes details regarding a meeting topic and meeting action item information. The communication server 328 may also receive topic information from the recording analysis engine 364. The communication server 328 may provide the communication information to the topic analysis event inputs 325. The communication server 328 may determine that the communication information has topics or sub-topics associated therewith by analyzing (e.g., scanning and processing) the communication information. As described herein, the communication information can be analyzed by identifying key words associated with defined topics, repeated words, repetitions of key words, etc. The rules for identifying topic information to input to the topic analysis event inputs 325 may be established automatically (for example based on thresholds), by machine learning, or they may be defined by a user or entity. The meeting action items that have topics associated therewith may be provided as input to the topic analysis event inputs 325 by the communication server 328. Alternatively, the communication server 328 may provide none or only some of the topic information to the topic analysis event inputs 325 based on one or more rules.

The communication server 328 may provide any information to the text analysis event inputs 324 and the topic analysis event inputs 325, including information not necessarily related to textual information and topic information. In various embodiments, the text analysis engine 348 and the topic analysis engine 352 may be responsible for processing (e.g., scanning, sorting, and editing) the information received from the communication server 328. Thus, portions or all of the same information may be provided to the text analysis event inputs 324 and the topic analysis event inputs 325.

Using the text analysis event inputs 324 and the historical text database 316, the text analysis engine 348 may be configured to recommend and/or implement one or multiple organizational actions as a text analysis event decision 320. The text analysis engine 348 may use rules and thresholds to determine organizational actions. The organizational actions from the text analysis engine 348 may be coordinated, edited, or otherwise managed by other components in system 300, for example, the intelligent organizer engine 332. The text analysis event decision 320 may be provided as an output of the intelligent organizer engine 332 back to the communication server 328. In some embodiments, the text analysis event decision 320 may include instructions for suggesting/recommending and/or managing an organizational action, such as creating, displaying, updating, or editing an upcoming event or communication. The recommendation may be made to specific users 203A-203N and 205A-205N and sent to one or more communication devices (e.g., 204A-204N and/or 202A-202N) in various modalities.

For example, the text analysis engine 348 may receive meeting minutes and emails from the historical text database 316. The text analysis engine 348 may receive a notification of a new meeting event from the communication server 328. The text analysis engine 348 may analyze the meeting minutes and the text of the new meeting event to determine that they share specific key words, based on the repetition of the key words being greater than a defined value set as a threshold. For example, the key words may be repeated within the meeting minutes and the new meeting event at least four times). The text analysis engine 348 may then determine that the meeting minutes and the new meeting event are related (as defined by the threshold) and that they should be presented together in a consolidated view. The text analysis engine 348 may scan emails from the historical text database 316 to search for the key words and thereby determine that three different emails are related to the meeting minutes and the new meeting event, and that should be presented in the consolidated view. The text analysis engine 348 may then send (or display or otherwise communicate) a recommendation to update the consolidated view to one or more of the users 203A-203N and 205A-205N associated with the information. In some embodiments, the text analysis engine 348 may send, via the communication server 328, the recommendation to an organizer of the new meeting event. The text analysis engine 348 can also take other organizational actions as described herein, such as suggesting meeting discussion points or actions items based on the text analysis.

The topic analysis engine 352 may use the topic analysis event inputs 325 and the historical topic database 317 to recommend and/or implement one or multiple organizational actions as a topic analysis event decision 321. The topic analysis engine 352 may use rules and thresholds to determine organizational actions. The organizational actions from the topic analysis engine 352 may be coordinated, edited, or otherwise managed by other components in system 300, for example, the intelligent organizer engine 332. The topic analysis event decision 321 may be provided as an output of the intelligent organizer engine 332 back to the communication server 328. In some embodiments, the topic analysis event decision 321 may include instructions for suggesting/recommending and/or managing an organizational action, such as creating, displaying, updating, or editing an upcoming event or communication. The recommendation may be made to one or more specific users 203A-203N and 205A-205N and sent to one or more communication devices (e.g., 204A-204N and/or 202A-202N) in various modalities.

Similar to the text analysis engine 348, the topic analysis engine 352 may analyze information to determine what is relevant to previously defined topics, or to determine new topics or topic recommendations. The topic analysis engine 352 may do so using previously identified topics from the historical topic database 317, or by using input from the topic analysis event inputs 325. For example, the topic analysis engine 352 may process (e.g., scan or search) information for repeated words, specific key words, words that are identified as a “topics” (also known as “subjects,” “themes,” and “issues,” among others), words in certain locations, etc. The topic analysis engine 352 may provide information about organizational actions or additional information about topics to the topic analysis event decisions 321, and the topic analysis event decisions 321 may provide some or all of the information to the communication server 328. Thus, the topic analysis event decision 321 may be provided as an output of the intelligent organizer engine 332 back to the communication server 328.

The recording analysis engine 364 may provide input to, and receive input from, a historical recordings database 367 and a recordings decision database 369. The recordings analysis engine 364 may receive input from the communication server 328 and provide input to the communication server 328. For example, the communication server 328 may receive a voicemail and meeting minutes from a user. The communication server 328 may provide the voicemail and meeting minutes to the recording analysis engine 364 to be analyzed. The recording analysis engine 364 may perform an analysis of the audio data using historical recordings database 367 to process the audio data (e.g., perform comparisons with historical audio data), and may provide the results of the processing to the recordings decision database 369 to be saved for future use. Using the historical recordings database 367 and the recordings decision database 369, the recording analysis engine 364 may be configured to recommend one or multiple organizational actions to the communication server 328, or to provide recordings information to the communication server 328.

In various embodiments, the recording analysis engine 364 may be a part of the intelligent organizer engine 332. Further, the recording analysis engine 364 may be configured to use machine learning, similar to the text analysis engine 348 and the topic analysis engine 352. The recording analysis engine 364 may share components (e.g., training data and feedback, data model(s), etc.) with one or more of the text analysis engine 348 and the topic analysis engine 352. Alternatively, one or more of the text analysis engine 348 and the topic analysis engine 352 may have a configuration similar to the recording analysis engine 364.

When the intelligent organizer engine 332, or components thereof, searches for additional information, the intelligent organizer engine 332 may perform a one-time search, multiple one-time searches, and/or continuous monitoring. During monitoring, the intelligent organizer server 332 may process incoming information (e.g., emails, recordings, calendar information, etc.) as it is received. To process the information, the information can be scanned, searched, parsed, and analyzed (including performing semantic and/or syntactic analysis), and any type of data within the information may be compared to one or more thresholds. Also, as described herein, properties of the information itself may be compared one or more thresholds. During the processing, data including results of the analysis may be stored for future use.

The thresholds to which data is compared may take any form. Thresholds may be set based on various criteria, and multiple thresholds may be set with different organizational actions taken at various thresholds, or the same organizational actions taken at various thresholds. For example, a first threshold may be set to configure and display a consolidated view after receiving three emails and/or other communications mentioning the key words “bug scrub” with “Revision 2.2.1” and “security.” A second threshold may be set to configure a proposed action item for any mention of the key words “Revision 2.2.2” within the set of communications applicable to the first threshold. The consolidated view for the first threshold may include a setting or rule to perform a search to determine a location where relevant information mentioned in the set of communications is saved, and to provide the information, or links to the information, within the consolidated view. For example, the information may be linked as a hyperlink or a URL. For the second threshold, a setting or rule may be in place for the system to prompt the user viewing the consolidated view to confirm whether the proposed action item should be created, edited, or deleted. Additional organizational actions may be created based on other variables, such as a timing of the communications detected (e.g., whether they are received within a certain week or number of hours), and/or if the communications occur over a specified period of time (e.g., if the communications are all received within a certain number of days from a specified meeting. Such thresholds may be pre-set (e.g., previously configured or pre-determined), and may change based on any criteria. In addition, thresholds may be set automatically and changed automatically (for example based on other thresholds), by machine learning, or they may be defined by a user or entity.

To enhance capabilities of the intelligent organizer engine 332, the intelligent organizer engine 332 may constantly be provided with updated training data 360 and 361. The training data may be communication inputs in the form of communication information, including real-time communication data from users 203A-203N and 205A-205N. It is possible to train the intelligent organizer engine 332 to have a particular output or multiple outputs.

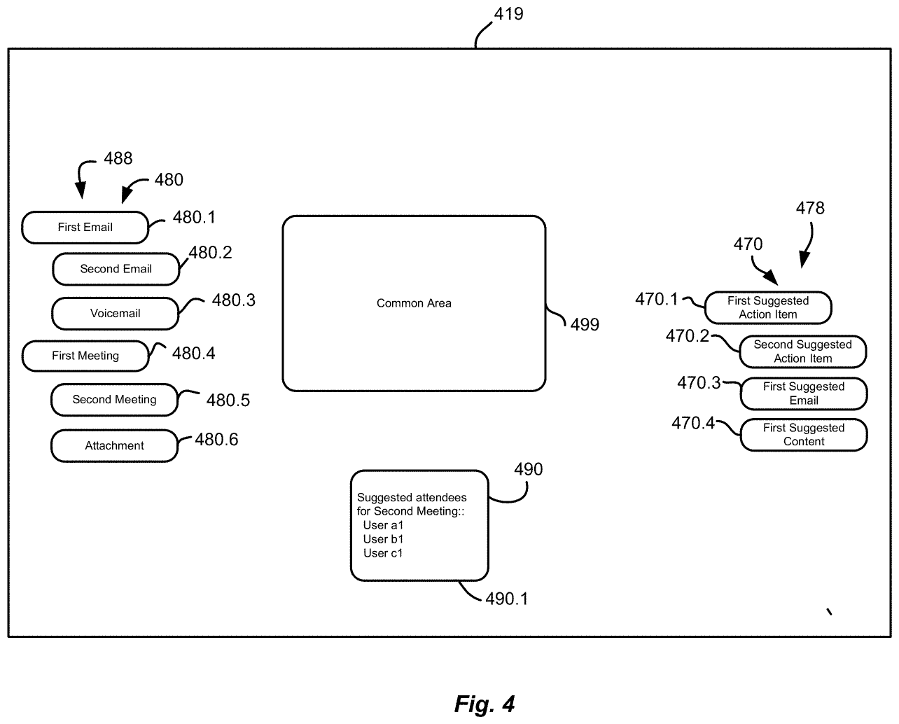

FIG. 4 is a depiction of an illustrative user interface 419 in accordance with embodiments of the present disclosure. In some aspects, the components shown in FIG. 4 may correspond to like components shown in FIGS. 1-3. More particularly, the user interface 419 can be generated by or in connection with the operation of the intelligent organizer engine 332, e.g., as an output of the intelligent organizer engine 332. The user interface 419 (also referred to herein as a consolidated view or a related items user interface) may be created by an organizational action. The user interface 419 includes different items of information. Automatic processing, user input, and/or machine learning input can determine how the consolidated view is configured, as well as updates to the user interface that configure the consolidated view. In some embodiments, the updates may remove unrelated information or adjust the interface based on varying importance or relevance of different pieces of information.

Thus, the user interface 419 may be interactive, and can be manipulated in response to input by automated processes (e.g., by using comparisons to thresholds), by machine learning, and/or by a user. A user may provide input, for example, through one or more communication devices (e.g., 204A-204N and/or 202A-202N) comprising a position encoder or, where the user interface 419 is provided as part of a touch screen display, for example as part of a tablet computer, various items of information can be moved, accessed, selected, or otherwise manipulated directly.

In accordance with at least some embodiments of the present disclosure, the user interface 419 can include tabs, menu(s), windows including browser windows, listings, or other ways of presenting configurable items of information. More particularly, a first list 488 can include a number of listings 480, which may appear as tabs and/or other displays, for example, that present information regarding content that is linked as relevant. The list 488 and the content of the list 488 (including relevancies or importance of the pieces of information) can be based, for example, on an analysis of thresholds as they compare to key words or topics of the content in connection with the operation of the intelligent organizer engine 332. The information may be content that is currently being accessed, that has been accessed in the past, or that has not be accessed by one or more particular users. The information can include a topic or brief description of the content and any associated piece of information (e.g., related thresholds, communication, and/or events).

The list 488 and the pieces of information within the list 488 may be determined using one or more thresholds. For example, a common topic in a second meeting can be identified by the intelligent organizer engine 332 when the intelligent organizer engine 332 identifies historically important content based on a number of repetitions of key words together with location of key words. The intelligent organizer engine 332 may thereby identify the second meeting when the second meeting contains another mention of the key words and thereby meets the threshold. Actions associated with the threshold can cause the intelligent organizer engine 332 to search for other content from information obtained from the communication server 328, including information in the historical text database 316, the historical topic database 317, and the historical recordings database 367. For example, the second meeting may be stored on the communication server 328 and thereby found by the intelligent organizer engine 332 during the search for the key words. The intelligent organizer engine 332 then includes the second meeting in the first list 488 as tile 480.5.

After the second meeting is identified and the user interface having the list 488 that includes the second meeting tile 480.5 configured, the intelligent organizer engine 332 may operate on another threshold by searching for and identifying an important content within the second meeting. The important content in the second meeting is obtained by a user defined rule that specifies that any content with the words “bug scrub” in it should have a topic of the bug scrub identified and other information that is related to the topic of the bug scrub included in the list 488. Thus, the intelligent organizer engine 332 searches for important content in information from the communication server 328 and finds a first meeting (which occurred before the second meeting) that contains the topic. The intelligent organizer engine 332 then includes the first meeting in the first list 488 as tile 480.4. In addition, the intelligent organizer finds an attachment associated with the second meeting (e.g., as an attached document within the second meeting) that it includes in the first list 488 as sixth tile 480.6, as well as a voicemail 480.3, a first email (tile 480.1), and a second email 480.2. The intelligent organizer engine 332 may thereby identify an upcoming meeting that has related content (e.g., content containing important content and a common topic) and require an organizational action of collecting and displaying the related content (e.g., related pieces of information) in a consolidated view (e.g., list 488).

In some embodiments, a list of information within the user interface may be displayed within a tab containing the information. In general, the status tiles 480 can contain current or historical information as well as recommended or suggested information and content. For example, status tiles 480 may contain a tile for a suggested meeting or suggested action items. suggested information may be reviewed and approved/disapproved by a user. Alternatively, the intelligent organizer engine 332 can automatically perform actions related to relevant content, such as scheduling a meeting (including sending invites to attendees, determining a meeting agenda or topic(s), and reserving a conference room or teleconference number), sending email(s), saving action item(s), setting notifications, etc.

Moreover, different status tiles 480 can be provided with respect to various tabs associated with different sets of relevant content. Status tiles 480 can be provided to present information regarding in-progress communication sessions (e.g., meetings, voice telephony calls, instant messages, etc.) as they are occurring. The individual status tiles 480 can contain information in addition to a general and/or specific identification of the content. For example, information concerning the meeting minutes of a meeting, the attendees of a meeting, or other information can be included in an individual tile. Moreover, at least some of this information can be displayed in a default configuration, while other items of information can be accessed by selecting or otherwise drilling down into desired associated information, for example by clicking on or otherwise selecting an individual tile in the first list 488. In accordance with still other embodiments of the present disclosure, the content to which a tile in the first list 488 is related can be represented by presenting a frame, screen scrape, series of frames, or other representation of the actual content in the associated tile. Accordingly, historical and/or current status information regarding content that has or is being accessed by the communication server 328, or that is available to the communication server 328, regarding a plurality of items of content can be displayed simultaneously. Thus, by selecting a status tile 480, a user can access additional information about the represented content. For example, the user can access details about the communication session, the meeting, attendees of a meeting, etc. Accordingly, the user interface 419 provides a means by which a user can select, interact with, or manipulate content.

A second list 478 of information in the consolidated view can also be provided. In accordance with illustrative embodiments of the present disclosure, the second list 478 can include suggestion tiles 470 that may be pop-up indicators or small windows that are displayed in response to information associated with the first list 488. The second list 478 may have an appearance that is similar to, or different from, the first list 488. The suggestion tiles 470 presented in the second list 478 can comprise dynamic tiles that alert user(s) to additional organizational actions that are recommended or suggested. These suggestion tiles 470 are recommendations because they may require a user's approval before being added to the consolidated view as a more permanent piece of information or before being implemented (e.g., by confirming meeting details and thereby causing the meeting to be scheduled and added to the consolidated view, by confirming an email's details and thereby causing the email to be sent and added to the consolidated view, etc.). In some embodiments, selection of one or more of the suggestion tiles 470 may allow a user to view, edit, and delete any of the information in the suggestion tiles 470.

Some of the suggestion tiles 470 may be recommended organizational actions if the user or system may take an action using the tile. For example, based on information in the first meeting 480.4 and the second meeting 480.5, the intelligent organizer engine 332 may create a first suggested action item 470.1 and a second suggested action item 470.2 and present each of these to a user for review. The intelligent organizer engine 332 may also draft and present a first suggested email 470.3 based on the first suggested action item 470.1 and the second suggested action item 470.2 to notify relevant users 203A-203N and 205A-205N of the action items. Further, the intelligent organizer engine 332 may provide a first suggested content 470.4 to include in the consolidated view that is a document related to the action item 470.2. By selecting and editing the suggestion tiles 470, a user may add or remove items from the consolidated view of the user interface 419. In addition, upon approval of the suggestion tiles, each of the approved tiles may be implemented by the system (e.g., the action items 470.1 and 470.2 may be scheduled and the email 470.3 may be sent).

The user interface 419 also allows the user to view and edit detailed information regarding the suggestions presented in suggestion tiles 470. For example, by selecting a suggestion tile, a user can access additional detail. Such detail can include additional information about the suggested content, communication, event, or the like. By selecting a suggestion tile 470, a user can also access the suggested content or take action with respect to a suggested activity. For instance, by selecting a suggested organizational action (e.g., the suggestion tile 470.3 that recommends an email to send) the user can view the content (e.g., the body of the email), change the content (e.g., change content within the body of the email, change recipients of the email, etc.), and take action on the content (e.g., approve to send the email). In various embodiments, a user may cause the suggested items to be acted upon by the system after providing a confirmation of the items.

Any rendering of one or more of the tiles 480 and 470 can alter the user interface display 419 to preferentially display selected information (e.g., selected information can be presented as a sub-frame or window as part of the display 419), or may replace the user interface display 419, or can be displayed on an affiliated device. In some embodiments, with respect to suggested organizational actions, selection can result in presenting the user with a fillable form to enable the user to take further action with respect to the action.

Additional embodiments of the present disclosure allow for suggested users 490 to be generated. In particular, users 490 can be generated through an analysis of information by the intelligent organizer engine 332. Various criteria can be applied to identify appropriate members for the users 490. Such criteria can include user job title, user associations, geographical location, and past user inclusion or exclusion from related communications or events, among other information. Thus, suggested users 490 can be created through operation of the intelligent organizer engine 332, and presented to a user by the user interface 419. The intelligent organizer engine 332 can also store and/or access user information, for example information that is stored as part of a user profile. A user of the user interface 419 can also adjust the users shown in the consolidated view. For example, users may be added or removed from the consolidated view, added or removed from content in suggestion tiles 470, and otherwise configured (such as added or removed from groups or lists).

In various aspects, one or more timelines may be incorporated into the consolidated view. For example, a timeline may be shown in one or more areas of the consolidated view that shows and/or links to information within the consolidated views. The timeline, and information associated with the timeline, may be configured or determined by a user, automatically by the system, and/or by machine learning. Further, updates and/or changes associated with the timeline (e.g., for tracking progress and deadlines or results of information within the timeline) may be performed by a user, automatically by the system, and/or by machine learning. The timeline(s) may be incorporated in any manner into the consolidated view. Illustratively, in FIG. 4, different items of information are displayed to convey information about a timeline. For example, the indentations of the items of information can indicate timeline information (e.g., second meeting 480.5 is indented from first meeting 480.4 to show that the second meeting occurred after the first meeting). Any other forms of visual arrangement and indication of properties may be used, including more traditional ways of displaying timelines that contain dates and/or timeframes associated with the information.

In some embodiments the user interface may have a common area 499 of the consolidated view where the consolidated view may be updated. For example, a user may drag or otherwise move information (e.g., one or more tiles from the first list 488, one or more tiles from the second list 478, and/or one or more users 490) into or out of the common area 499. Although one common area 499 is shown in FIG. 4, multiple common areas may be used. Thus, the areas of the user interface may be configured in any manner, and multiple common areas may be presented simultaneously by the user interface 419. Various types of visual indications may be used to organize the user interface 419 and inform the user of certain information or suggestions by the intelligent organizer engine 332. In some aspects, execution of organizational actions can be triggered by moving the information and/or organizational action to the common area 499.

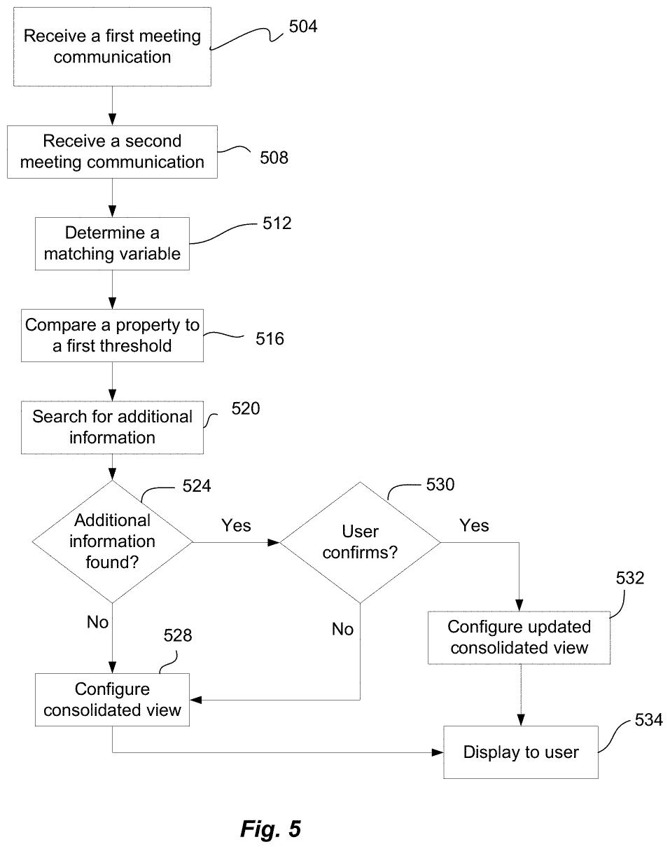

Referring now to FIG. 5, a method will be described in accordance with at least some embodiments of the present disclosure. The method begins when a first meeting communication is received at step 504. The first meeting communication may be received from a communication device (e.g., 204A-204N and/or 202A-202N) or from communication server 328. The first meeting communication may be received by the intelligent organizer engine 332.

The method continues with a second meeting communication being received at step 508. Similar to the first meeting communication, the second meeting communication may be received from a communication device (e.g., 204A-204N and/or 202A-202N) or from communication server 328. The second meeting communication may also be received by the intelligent organizer engine 332.

At step 512 a matching variable is determined. For example, when each of the first and second meeting communications are received, they may be processed by the intelligent organizer engine 332 to determine any key words within their content, and the intelligent organizer engine 332 may determine that they contain a matching variable (e.g., a same set of key words). This processing may be done at the time of receipt, at the time the latter communication is received (e.g., the first meeting communication may be saved until the second meeting communication is received, at which point the system may access the saved first meeting communication to process it during or after the second meeting communication is processed), or at a later time (e.g., both the first and second meeting communications may be saved to analyze at a later time). The timing of the processing may be dependent on rules associated with a threshold. Matching variables, and data related to the matching variables (as well as the communications themselves), may be stored in one or more databases of communication decisions (e.g., text decision database 312, topic decision database 313, and/or recordings decision database 369).

In various embodiments, the first meeting communication may be an email communication and be sent from the communication server 328 to each of the text analysis event inputs 324 and the topic analysis event inputs 325. The text analysis event inputs 324 forwards the first meeting communication to the text analysis engine 348, which performs processing (e.g., scans the content of the email and identifies key phrases and related information within the email). Key phrases may have been previously identified by one or more users 203A-203N and 205A-205N (or by machine learning using the text analysis learning/training module 309) and stored in the historical text database 316. The text analysis engine 348 thereby scans the email for the key phrases and identifies multiple key phrases. The text analysis engine 348 also scans the email for repeated key words and indicators of importance for key words and determines a ranking of importance for the identified key words.

The second meeting communication may correspond to a voicemail message and it is sent from the communication server 328 to the recording analysis engine 364. The recording analysis engine 364 may parse and analyze the content of the second meeting communication, for example, by comparing the content to information in the historical recordings database 367. The recording analysis engine 364 may compare content from the second meeting communication to key phrases that were previously identified by one or more users 203A-203N and 205A-205N, or by the intelligent organizer engine 332, and stored in the historical recordings database 367 in association with another, different, meeting communication. The recording analysis engine 364 may scan the voicemail message for repeated key words and indicators of importance for key words and determine a ranking of importance for the identified key words.

The matching variable determined in step 512 may be matching content, such as matching key words that are contained in each of the first meeting communication and the second meeting communication. The matching content may be based on the content's occurrence within a specified area of the communication (e.g., each of the key words occur within a subject line of the email) or based on a property of the occurrence (e.g., a number of repetitions of the key word(s) within all of the content within each of the first meeting communication and the second meeting communication).

At step 516 a property of the matching variable is compared to a first threshold. For example, the property may be a level of importance of the matching variable, a number of repetitions of one or more key words, and/or a location of key words, among other properties. The threshold may be set so that if the threshold is met, then an organizational action is performed. Based on the matching variable, an organizational action may be taken, such as configuring a consolidated view as discussed in steps 528 and 532. In some embodiments, the organizational action may be configured immediately after the property is compared, and in other embodiments the organizational action may not be configured until after any additional information is searched for, as explained illustratively in step 520. Details of the organizational action and timing of the organizational action may be set based on rules and/or thresholds.

Additional information is searched for at step 520. The additional information may be searched for from various communication channels and/or databases. The search may be dependent upon details related to the matching variable, the property of the matching variable and/or the threshold. Additionally, another rule or threshold may configure any searching for additional information. For example, if the threshold is exceeded by at least a certain amount, or if a level of importance of the key words is determined to exceed a defined amount, then the system may be set to perform a search immediately (e.g., before any consolidated view is configured and displayed, or while a consolidated view is being configured and displayed).

At step 524, it is determined whether additional information is found. Similar to the other methods described herein, details of how this step occurs may be dependent on details of information, and may be configured and implemented automatically, by machine learning, or from rules set by a user. If additional information is found, then the method proceeds to step 530 where a user can confirm whether to add the additional information to a consolidated view.

If the user confirms to add the additional information, then the consolidated view is updated to add the additional information at step 532. This can result in an updated consolidated view. In some embodiments, the system may confirm changes to the consolidated view with the user or an administrator, or may allow the user to configure the updates to the consolidated view. For example, the system can allow the user to select which actions to perform with the additional information with respect to adding the additional information to the consolidated view.

If the user does not confirm to add the additional information, then the method proceeds to step 528 to configure the consolidated view without adding any of the additional information. Returning to step 524, if no additional information is found at step 524, then the method proceeds to step 528 to configure the consolidated view without the additional information. After configuring the consolidated view or the updated consolidated view, the respective consolidated view is displayed to the user at step 534.

The present disclosure, in various aspects, embodiments, and/or configurations, includes components, methods, processes, systems, and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method of managing communications, the method comprising:
receiving a first meeting communication;
receiving a second meeting communication;
determining at least one matching variable in common between the first meeting communication and the second meeting communication;
comparing a property of the at least one matching variable to a first threshold to determine a configuration of an organizational action; and
based on the comparison of the property, performing the organizational action.

2. The method of claim 1, wherein the performing the organizational action comprises at least one of: displaying a related items user interface, displaying a follow up user interface, and displaying a meeting summary based on a content of a first meeting.

3. The method of claim 1, wherein the performing the organizational action comprises displaying a related items user interface, wherein the related items user interface comprises a display of the first meeting communication and a display of the second meeting communication.

4. The method of claim 3, further comprising:
after the comparing the property to the first threshold and before the performing the organizational action, searching at least one of a calendar and an email history to find an additional communication related to the at least one matching variable; and
requesting a user input to configure a consolidated view of the first meeting communication, the second meeting communication, and the additional communication.

5. The method of claim 1, wherein the performing the organizational action is configuring first information about the first meeting communication and second information about the second meeting communication into a consolidated view, and further comprising displaying the consolidated view on a display device.

6. The method of claim 5, further comprising:
after the comparing the property to the first threshold and before the performing the organizational action, searching at least one of a calendar and an email history to find an additional communication related to the at least one matching variable,
wherein the performing the organizational action further comprises configuring additional information about the additional communication into the consolidated view to create an updated consolidated view, and
wherein the displaying the consolidated view includes displaying the updated consolidated view.

7. The method of claim 1, further comprising:
after the comparing of the property to the first threshold, monitoring for the at least one matching variable, wherein at least one of the first meeting communication and the second meeting communication are related to a first user, and wherein the monitoring is of an activity of the first user.

8. The method of claim 7, wherein the monitoring detects an event containing the at least one matching variable, wherein the performing the organizational action is configuring first information about the first meeting communication and second information about the second meeting communication into a first consolidated view, and further comprising:
displaying the first consolidated view on a display device; and
displaying a second consolidated view on the display device, wherein the second consolidated view comprises third information about the event.

9. The method of claim 1, further comprising:
storing the at least one matching variable in a database of communication decisions;
enabling a machine learning process to analyze the database of communication decisions; and
updating a data model used to automatically perform, based on the analysis performed by the machine learning process, analyses of matching variables including the analysis of the at least one matching variable.

10. The method of claim 9, wherein the first meeting communication is a first calendar event having a first voice-to-text transcript, wherein the second meeting communication is a second calendar event having a second voice-to-text transcript, and wherein the at least one matching variable is a shared meeting topic obtained by the machine learning process from the first voice-to-text transcript and the second voice-to-text transcript.

11. The method of claim 10, further comprising updating the database of communication decisions to store the shared meeting topic.

12. The method of claim 9, wherein the first threshold is set by the machine learning process and wherein the first threshold is stored in the database of communication decisions.

13. The method of claim 1, wherein the organizational action comprises recording at least one of a first meeting corresponding to the first meeting communication and a second meeting corresponding to the second meeting communication, and wherein the organizational action further comprises updating, with a link to the recording, a consolidated view comprising the first meeting communication and the second meeting communication.

14. The method of claim 10, wherein the machine learning process obtains the first voice-to-text transcript and the second voice-to-text transcript, and wherein the machine learning process performs a semantic and/or syntactic analysis of text within the first voice-to-text transcript and the second voice-to-text transcript to obtain the shared meeting topic.

15. The method of claim 9, wherein the first threshold is determined by the machine learning process after the receiving the first meeting and after the receiving second meeting communication, and wherein the first threshold is stored in the database of communication decisions.

16. A communication system, comprising:
a processor; and
computer memory storing data thereon that enables the processor to:
receive a first meeting communication;
receive a second meeting communication;
determine at least one matching variable in common between the first meeting communication and the second meeting communication;
compare a property of the at least one matching variable to a first threshold to determine a configuration of an organizational action; and
based on the comparison of the property, perform the organizational action.

17. The communication system of claim 16, wherein the first meeting communication is an email, the second meeting communication is a calendar event, the property is a key word, and the threshold is a number of repetitions of the key word.

18. The communication system of claim 16, wherein the first meeting communication is an email, the second meeting communication is a calendar event, the property is a key word, and the threshold is a location of the key word in each of the email and the calendar event.

19. The communication system of claim 16, wherein the performing the organizational action is at least one of creating a new calendar event and creating an action item, wherein the organizational action is based on information from at least one of the first meeting communication and the second meeting communication, and further comprising displaying a confirmation for the organizational action on a display device.

20. A contact center, comprising:
a server comprising a processor and a message routing engine that is executable by the processor and that enables the processor to:
receive a first meeting communication;
receive a second meeting communication;
determine at least one matching variable in common between the first meeting communication and the second meeting communication;
compare a property of the at least one matching variable to a first threshold to determine a configuration of an organizational action; and
based on the comparison of the property, perform the organizational action.
